(19) United States
(12) Patent Application Publication
(10) Pub. No.: US 2023/0042626 A1
(43) Pub. Date: Feb. 9, 2023

(54) CONTROL APPARATUS FOR INTERNAL COMBUSTION ENGINE

(71) Applicant: TOYOTA JIDOSHA KABUSHIKI KAISHA, Toyota-shi (JP)

(72) Inventors: Koichi KITAURA, Odawara-shi (JP); Shigemasa HIROOKA, Susono-shi (JP); Shingo KORENAGA, Nagoya-shi (JP); Daichi IMAI, Sunto-gun (JP)

(73) Assignee: TOYOTA JIDOSHA KABUSHIKI KAISHA, Toyota-shi (JP)

(21) Appl. No.: 17/808,793

(22) Filed: Jun. 24, 2022

(30) Foreign Application Priority Data
Aug. 5, 2021 (JP) 2021-129143

(51) Int. Cl. F01N 9/00; F02D 41/02

(52) U.S. Cl. CPC F01N 9/002; F02D 41/029; F01N 2560/06; F01N 2900/1404; F02D 2200/08

(57) ABSTRACT

A control apparatus is applied to an internal combustion engine where an EHC and a filter are arranged in this sequence from an upstream side. The control apparatus performs a regeneration process for removing particulate matter deposited in the filter through oxidation, and a recovery process for raising the temperature of exhaust gas to a temperature higher than in the case of the regeneration process and removing the particulate matter deposited at a front end portion of the EHC through oxidation when it is determined that the insulation resistance of the EHC is equal to or lower than a prescribed value. The control apparatus performs the regeneration process and then the recovery process when it is determined that the insulation resistance is equal to or lower than the prescribed value and the deposition amount of the particulate matter in the filter is equal to or larger than a prescribed amount.

### CROSS-REFERENCE TO RELATED APPLICATION

This application claims priority to Japanese Patent Application No. 2021-129143 filed on Aug. 5, 2021, incorporated herein by reference in its entirety.

### BACKGROUND

### 1. Technical Field

This disclosure relates to a control apparatus for an internal combustion engine.

### 2. Description of Related Art

An exhaust gas control catalyst for controlling the emission of exhaust gas in an internal combustion engine sufficiently fulfills its potential at an activation temperature. Therefore, it may be impossible to sufficiently control the emission of exhaust gas when the temperature of the exhaust gas control catalyst is lower than the activation temperature, for example, at the time of cold start-up.

Thus, there is known an electrically heated catalyst having the function of a heater that generates heat by being supplied with electric power, as an exhaust gas control catalyst provided in an exhaust passage of an internal combustion engine. With the electrically heated catalyst, a preheating process for warming up the exhaust gas control catalyst by supplying electric power prior to the startup of the internal combustion engine can be performed.

In the electrically heated catalyst, there have been demands to ensure a sufficiently high insulation resistance with a view to suppressing the occurrence of electrical leakage. In Japanese Unexamined Patent Application Publication No. 2012-72665 (JP 2012-72665 A), there is disclosed a control apparatus that controls the energization of an electrically heated catalyst. The control apparatus of JP 2012-72665 A performs a recovery process for recovering the insulation resistance of the electrically heated catalyst when it is sensed that the insulation resistance is low.

Incidentally, it is disclosed in JP 2012-72665 A that an exhaust gas control catalyst is heated by delivering exhaust gas thereto through operation of an internal combustion engine, as the recovery process for removing particulate matter deposited at a front end of the electrically heated catalyst through oxidation.

Incidentally, an exhaust passage may be provided with a filter that collects the particulate matter in exhaust gas. When particulate matter is deposited in the filter, the resistance of exhaust gas in the exhaust passage increases. Therefore, a regeneration process for regenerating the filter by raising the temperature of exhaust gas flowing into the filter and removing the particulate matter deposited in the filter through oxidation may be performed.

### SUMMARY

The particulate matter deposited at the front end portion of the electrically heated catalyst is removed through oxidation, by the recovery process. In the case where the filter is provided downstream of the electrically heated catalyst in the exhaust passage, exhaust gas that has reached a higher temperature than the exhaust gas delivered to the electrically heated catalyst is introduced into the filter, due to oxidation heat of the particulate matter resulting from the recovery process and the reaction heat in the electrically heated catalyst. As a result, an oxidation reaction of the particulate matter deposited in the filter may progress in a chain-reaction manner, and the temperature of the filter may rise excessively.

Means for solving the aforementioned problem and the operation and effects thereof will be described hereinafter.

A control apparatus for an internal combustion engine is designed to solve the aforementioned problem. The internal combustion engine to which the control apparatus is applied is mounted with an electrically heated catalyst system having an electrically heated catalyst that is an exhaust gas control catalyst having a catalyst carried by a catalyst carrier generating heat through energization and that causes the catalyst carrier to generate heat by energizing the catalyst carrier, with the electrically heated catalyst and a filter for collecting particulate matter contained in exhaust gas arranged in an exhaust passage in a sequence of the electrically heated catalyst and the filter from an upstream side. The control apparatus performs a regeneration process for removing the particulate matter deposited in the filter through oxidation, and a recovery process for removing the particulate matter deposited at a front end portion of the electrically heated catalyst through oxidation when it is determined that an insulation resistance of the electrically heated catalyst is equal to or lower than a prescribed value. The regeneration process is a process of raising a temperature of exhaust gas discharged from a combustion chamber of the internal combustion engine to a temperature that is higher than prior to the start of the regeneration process. Besides, the recovery process is a process of raising the temperature of exhaust gas discharged from the combustion chamber to a temperature that is higher than in a case of the regeneration process. Moreover, the control apparatus performs the regeneration process and then the recovery process when it is determined that the insulation resistance is equal to or lower than the prescribed value and it is determined that a deposition amount of the particulate matter in the filter is equal to or larger than a prescribed amount.

According to the aforementioned configuration, the regeneration process is performed first, so the deposition amount of particulate matter in the filter is small when the recovery process is performed. Even in the case where the exhaust gas that has reached a high temperature due to the reaction heat on the upstream side resulting from the recovery process is introduced into the filter, if the deposition amount is small, the particulate matter burns off, and an oxidation reaction that occurs in a chain-reaction manner is likely to come to an end. Therefore, the temperature of the filter can be restrained from becoming excessively high.

In one aspect of the control apparatus for the internal combustion engine, the control apparatus may estimate the deposition amount based on a pressure of exhaust gas detected by an exhaust gas pressure sensor provided in the exhaust passage downstream of the electrically heated catalyst and upstream of the filter.

When particulate matter is deposited in the filter, the filter is clogged to make exhaust gas unlikely to flow. Therefore, the pressure of exhaust gas upstream of the filter becomes high. The pressure of exhaust gas detected by the exhaust gas pressure sensor provided downstream of the electrically heated catalyst and upstream of the filter rises as the flow resistance of exhaust gas resulting from this deposition of particulate matter increases. It is therefore possible to estimate a deposition amount based on the pressure of exhaust gas detected as in the aforementioned configuration, and determine, based on the estimated deposition amount, that the deposition amount of particulate matter is equal to or larger than the prescribed amount.

In another aspect of the control apparatus for the internal combustion engine, the electrically heated catalyst system may be equipped with an electrical leakage sensing circuit for detecting the insulation resistance, and the insulation resistance may be detected through the use of the electrical leakage sensing circuit.

In the case where the electrically heated catalyst system is equipped with the electrical leakage sensing circuit for detecting the insulation resistance, it is possible to determine, based on the insulation resistance detected through the use of the electrical leakage sensing circuit, that the insulation resistance is equal to or lower than the prescribed value.

In still another aspect of the control apparatus for the internal combustion engine, the control apparatus may raise the temperature of exhaust gas by retarding an ignition timing in the internal combustion engine, in the regeneration process and the recovery process. In the regeneration process and the recovery process, the temperature of exhaust gas can be raised by retarding the ignition timing in the internal combustion engine, as in the aforementioned configuration.

In still another aspect of the control apparatus for the internal combustion engine, the control apparatus may end the regeneration process with the deposition amount being larger than in a case where the regeneration process is performed when it is not determined that the insulation resistance is equal to or lower than the prescribed value, and starts the recovery process, in a case where the regeneration process is performed prior to the recovery process when it is determined that the insulation resistance is equal to or lower than the prescribed value and it is determined that the deposition amount is equal to or larger than the prescribed amount.

In the case where the regeneration process is performed prior to the recovery process, high-temperature exhaust gas continues to be introduced into the filter during the performance of the recovery process that is performed subsequently to the regeneration process as well. Therefore, the particulate matter deposited in the filter can be oxidated during the performance of the recovery process as well. Accordingly, even when the regeneration process is ended with the deposition amount being larger than in the case where the regeneration process is performed when it is not determined that the insulation resistance is equal to or lower than the prescribed value, the deposition amount can be reduced sufficiently. According to the aforementioned configuration, the period during which the regeneration process is performed can be shortened to make a swift shift to the recovery process.

In still another aspect of the control apparatus for the internal combustion engine, the control apparatus may shorten a period during which the recovery process is performed as an amount of oxygen contained in exhaust gas discharged from the combustion chamber increases.

The likelihood of oxidation of particulate matter increases as the amount of oxygen increases. Therefore, the period during which the recovery process is performed can be shortened as the amount of oxygen contained in exhaust gas increases. According to the aforementioned configuration, the period during which the recovery process is performed is shortened as the amount of oxygen contained in exhaust gas increases, in accordance with these circumstances. Therefore, the recovery process can be restrained from being performed more than necessary.

In still another aspect of the control apparatus for the internal combustion engine, the control apparatus may set a counter to a prescribed value when it is determined that the insulation resistance is equal to or lower than the prescribed value. Moreover, the control apparatus may repeatedly subtract, from a value of the counter, a subtraction amount that is set in such a manner as to increase as the amount of oxygen increases, during the performance of the recovery process, and end the recovery process when the value of the counter falls to or below an end determination value. By adopting this configuration, it is possible to realize the configuration for shortening the period during which the recovery process is performed as the amount of oxygen contained in exhaust gas discharged from the combustion chamber increases.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a relationship between a control apparatus that is one of the embodiments of a control apparatus for an internal combustion engine and a vehicle that is equipped with the internal combustion engine controlled by the control apparatus;

FIG. 2 is a schematic view showing the general configuration of an electrically heated catalyst system mounted in the vehicle;

FIG. 3 is a flowchart showing the flow of a series of processing steps in a routine regarding the operation of an insulation recovery request;

FIG. 4 is a flowchart showing the flow of a series of processing steps that are carried out when the insulation recovery request is ON;

FIG. 5A shows changes in the state of the insulation recovery request in a time chart showing changes in various states at the time when it is determined that a deposition amount PM is equal to or larger than a prescribed amount PM_x and that an insulation resistance Rt is equal to or lower than a prescribed value Rt x;

FIG. 5B shows changes in the deposition amount PM in the time chart showing changes in various states at the time when it is determined that the deposition amount PM is equal to or larger than the prescribed amount PM_x and that the insulation resistance Rt is equal to or lower than the prescribed value Rt_x;

FIG. 5C shows changes in a target temperature in the time chart showing changes in various states at the time when it is determined that the deposition amount PM is equal to or larger than the prescribed amount PM_x and that the insulation resistance Rt is equal to or lower than the prescribed value Rt_x;

FIG. 5D shows changes in the value of a counter CNT in the time chart showing changes in various states at the time when it is determined that the deposition amount PM is equal to or larger than the prescribed amount PM_x and that the insulation resistance Rt is equal to or lower than the prescribed value Rt_x;

FIG. 6A shows changes in the state of the insulation recovery request in a time chart showing changes in various states at the time when it is determined that the deposition amount PM is smaller than the prescribed amount PM_x and the insulation resistance Rt is equal to or lower than a prescribed value Tt_x;

FIG. 6B shows changes in the deposition amount PM in the time chart showing changes in various states at the time when it is determined that the deposition amount PM is smaller than the prescribed amount PM_x and the insulation resistance Rt is equal to or lower than the prescribed value Tt_x;

FIG. 6C shows changes in the target temperature in the time chart showing changes in various states at the time when it is determined that the deposition amount PM is smaller than the prescribed amount PM_x and the insulation resistance Rt is equal to or lower than the prescribed value Tt_x; and

FIG. 6D shows changes in the value of the counter CNT in the time chart showing changes in various states at the time when it is determined that the deposition amount PM is smaller than the prescribed amount PM_x and the insulation resistance Rt is equal to or lower than the prescribed value Tt_x.

### DETAILED DESCRIPTION OF EMBODIMENTS

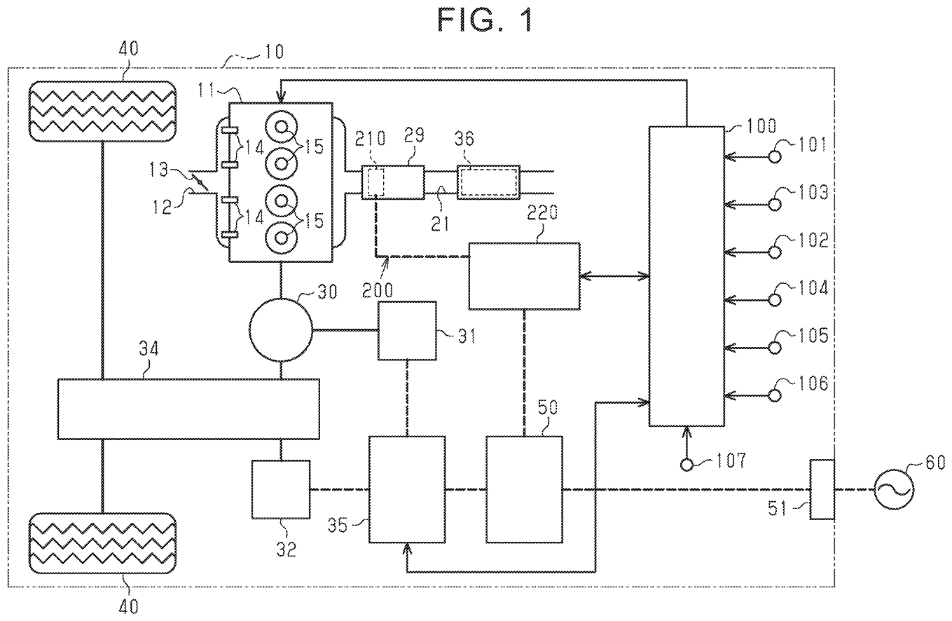

A control apparatus 100 that is a control apparatus for an internal combustion engine according to one of the embodiments will be described hereinafter with reference to FIGS. 1 to 6D.

Configuration of Vehicle 10

First of all, the configuration of a vehicle 10 mounted with the control apparatus 100 will be described with reference to FIG. 1.

As shown in FIG. 1, the vehicle 10 is equipped with an internal combustion engine 11 and a second motor-generator 32 as motive power sources. That is, the vehicle 10 is a hybrid electric vehicle. Incidentally, the vehicle 10 is one of various types of hybrid electric vehicles, namely, a plug-in hybrid electric vehicle that can be connected to an external electric power supply 60 to charge a battery 50. Therefore, a charger 51 for external charging is connected to the battery 50. Incidentally, the battery 50 is a high-voltage battery of, for example, 400 V. Besides, the second motor-generator 32 is, for example, a three-phase alternating current-type motor-generator.

The internal combustion engine 11 is equipped with an intake passage 12 and an exhaust passage 21. Incidentally, in the example shown in FIG. 1, the internal combustion engine 11 is equipped with four cylinders. A throttle valve 13 for adjusting the flow rate of intake air flowing through the intake passage 12 is provided in the intake passage 12. The internal combustion engine 11 is provided with a plurality of fuel injection valves 14 that inject fuel into intake air, for the cylinders respectively. Incidentally, two or more fuel injection valves 14 may be provided for each of the cylinders, or the numbers of fuel injection valves 14 provided for the respective cylinders may be different from one another. Besides, the internal combustion engine 11 is provided with a plurality of ignition plugs 15 that ignite a mixture of fuel and intake air through spark discharge, for the cylinders respectively. Incidentally, two or more ignition plugs 15 may be provided for each of the cylinders, and the numbers of ignition plugs 15 provided for the respective cylinders may be different from one another.

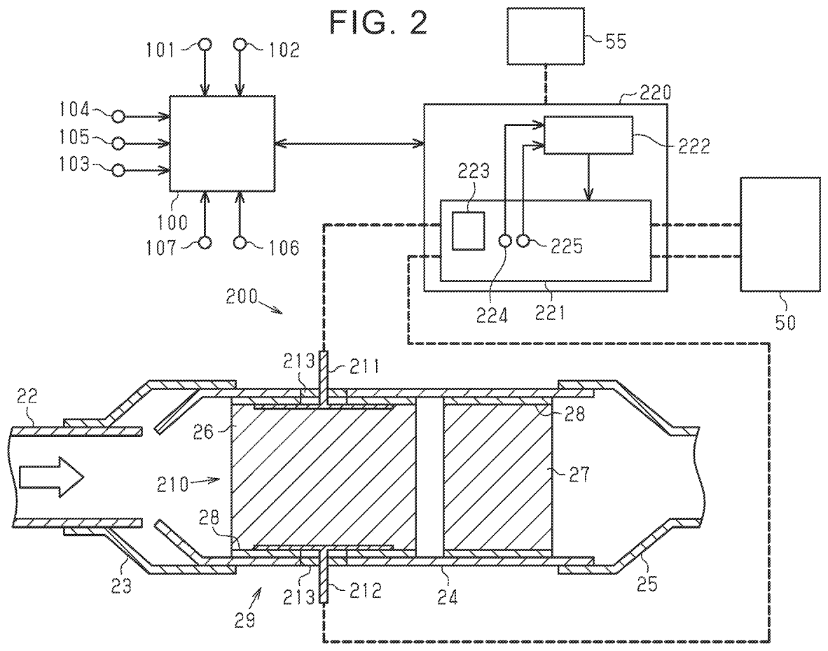

A catalytic converter 29 is installed in the exhaust passage 21 of the internal combustion engine 11. The catalytic converter 29 is mounted with an electrically heated catalyst 210 that generates heat in accordance with energization thereof. The electrically heated catalyst 210 is connected to the battery 50 via an electric power supply device 220. The detailed configuration of an electrically heated catalyst system 200 including the electrically heated catalyst 210 will be described later with reference to FIG. 2. Besides, a filter 36 is provided in the exhaust passage 21 downstream of the catalytic converter 29. The filter 36 collects particulate matter contained in exhaust gas. The particulate matter is a fine particulate material that consists mainly of carbon produced through combustion.

The second motor-generator 32 is connected to the battery 50 via a power control unit 35. The second motor-generator 32 is coupled to driving wheels 40 via a deceleration mechanism 34.

Besides, the internal combustion engine 11 is coupled to the driving wheels 40 via a motive power dividing mechanism 30 and the deceleration mechanism 34. Incidentally, a first motor-generator 31 is also coupled to the motive power dividing mechanism 30. The first motor-generator 31 is, for example, a three-phase alternating current-type motor-generator. The motive power dividing mechanism 30 is a planetary gear mechanism, and can divide a driving force of the internal combustion engine 11 into a driving force for the first motor-generator 31 and a driving force for the driving wheels 40.

The first motor-generator 31 generates electric power upon receiving the driving force of the internal combustion engine 11 and the driving force from the driving wheels 40. Besides, in starting up the internal combustion engine 11, the first motor-generator 31 also plays the role of a starter that drives a rotary shaft of the internal combustion engine 11. In this case, the first motor-generator 31 functions as a motor that generates a driving force as electric power from the battery 50 is supplied thereto.

The first motor-generator 31 and the second motor-generator 32 are connected to the battery 50 via the power control unit 35. An AC electric power generated by the first motor-generator 31 is converted into a DC electric power by the power control unit 35 to charge the battery 50. That is, the power control unit 35 functions as an inverter.

Besides, the DC electric power of the battery 50 is converted into an AC electric power by the power control unit 35 and supplied to the second motor-generator 32. Incidentally, in decelerating the vehicle 10, electric power is generated by the second motor-generator 32 through the use of the driving force from the driving wheels 40. The battery 50 is then charged with the generated electric power. That is, regenerative charging is carried out in the vehicle 10. In this case, the second motor-generator 32 functions as a generator. At this time, an AC electric power generated by the second motor-generator 32 is converted into a DC electric power by the power control unit 35 to charge the battery 50.

Incidentally, when the first motor-generator 31 is caused to function as a starter, the power control unit 35 converts the DC electric power of the battery 50 into an AC electric power, and supplies this AC electric power to the first motor-generator 31.

As for Control Apparatus 100

The control apparatus 100 controls the internal combustion engine 11, the first motor-generator 31, and the second motor-generator 32. That is, the control apparatus 100 is a control apparatus that controls a power train of the vehicle 10 that is a plug-in hybrid electric vehicle. Therefore, the control apparatus 100 controls the internal combustion engine 11 including the electrically heated catalyst system 200. In short, the control apparatus 100 is also a control apparatus that controls the internal combustion engine 11.

Detection signals of sensors provided at various portions of the vehicle 10 are input to the control apparatus 100. The detection signals input to the control apparatus 100 include a vehicle speed, an accelerator pedal depression amount, and a state of charge SOC corresponding to a remaining capacity of the battery 50. Besides, a coolant temperature sensor 101 that detects a coolant temperature Tw that is a temperature of coolant for the internal combustion engine 11 is connected to the control apparatus 100. Besides, a power switch 102 for allowing a driver of the vehicle 10 to activate and stop a system of the vehicle 10 is also connected to the control apparatus 100. Therefore, the control apparatus 100 grasps an activation state of the system of the vehicle 10, based on an input signal from the power switch 102. An upstream exhaust gas temperature sensor 103 that detects an exhaust gas temperature that is a temperature of exhaust gas discharged from the internal combustion engine 11 is connected to the control apparatus 100. Incidentally, the upstream exhaust gas temperature sensor 103 is arranged in the exhaust passage 21 upstream of the catalytic converter 29. Besides, a downstream exhaust gas temperature sensor 107 is arranged in a region of the exhaust passage 21 that is located downstream of the catalytic converter 29 and upstream of the filter 36. The downstream exhaust gas temperature sensor 107 detects a temperature of exhaust gas that has passed through the catalytic converter 29. Besides, as is the case with the upstream exhaust gas temperature sensor 103 and the downstream exhaust gas temperature sensor 107, air-fuel ratio sensors 105 and 106 are provided upstream and downstream of the catalytic converter 29 respectively. The upstream air-fuel ratio sensor 105 arranged in a region of the exhaust passage 21 that is located upstream of the catalytic converter 29 detects an air-fuel ratio of exhaust gas introduced into the catalytic converter 29. The downstream air-fuel ratio sensor 106 is arranged in the region of the exhaust passage 21 that is located downstream of the catalytic converter 29 and upstream of the filter 36. The downstream air-fuel ratio sensor 106 detects an air-fuel ratio of exhaust gas that has passed through the catalytic converter 29. Moreover, an exhaust gas pressure sensor 104 that detects a pressure of exhaust gas is arranged in a region of the exhaust passage 21 that is located between the catalytic converter 29 and the filter 36. These sensors are all connected to the control apparatus 100. Detection signals of these sensors are input to the control apparatus 100.

The vehicle 10 configured as described above can run in a motor-driven manner with the driving wheels 40 driven through the use of only the second motor-generator 32, by driving the second motor-generator 32 through the use of the electric power stored in the battery 50. Besides, the vehicle 10 can also run in a hybrid manner with the driving wheels 40 driven through the use of the internal combustion engine 11 and the second motor-generator 32.

Configuration of Electrically Heated Catalyst System 200

Next, the configuration of the electrically heated catalyst system 200 will be described with reference to FIG. 2. As shown in FIG. 2, the catalytic converter 29 is mounted with a second exhaust gas control catalyst 27 as well as a first exhaust gas control catalyst 26 that constitutes the electrically heated catalyst 210. Each of the first exhaust gas control catalyst 26 and the second exhaust gas control catalyst 27 is configured by a three-way catalyst carried on a catalyst carrier having a honeycomb structure where a plurality of passages extending in a direction in which exhaust gas flows are laid out.

The first exhaust gas control catalyst 26 and the second exhaust gas control catalyst 27 are accommodated in a case 24. The case 24 is a tube formed of a metal, for example, stainless steel. The case 24 is an exhaust pipe that constitutes part of the exhaust passage 21. In the case 24, a mat 28 is interposed between each of the first exhaust gas control catalyst 26 and the second exhaust gas control catalyst 27 and the case 24. The mat 28 is an insulator, and is formed of, for example, inorganic fiber consisting mainly of alumina.

The mat 28 is interposed, in a compressed state, between each of the first exhaust gas control catalyst 26 and the second exhaust gas control catalyst 27 and the case 24. Therefore, each of the first exhaust gas control catalyst 26 and the second exhaust gas control catalyst 27 is held in the case 24 due to a restoring force of the compressed mat 28.

An upstream connection pipe 23 that decreases in diameter with decreases in distance to an upstream side is overlaid on an upstream region of the case 24 from an outside and fixed thereto. Besides, a downstream connection pipe 25 that decreases in diameter with decreases in distance to a downstream side is overlaid on a downstream region of the case 24 from the outside and fixed thereto.

As shown in FIG. 2, the upstream connection pipe 23 connects an upstream exhaust pipe 22 that is smaller in diameter than the case 24 and the case 24 to each other. By the same token, the downstream connection pipe 25 connects a downstream exhaust pipe that is smaller in diameter than the case 24 and the case 24 to each other. In this manner, the case 24 that accommodates the first exhaust gas control catalyst 26 and the second exhaust gas control catalyst 27, the upstream connection pipe 23, and the downstream connection pipe 25 constitute the catalytic converter 29 that constitutes part of the exhaust passage 21.

Incidentally, an upstream end portion of the case 24 decreases in diameter with decreases in distance to the upstream exhaust pipe 22. The diameter of a region of the case 24 closest to the upstream exhaust pipe 22 is substantially equal to the diameter of the upstream exhaust pipe 22.

The first exhaust gas control catalyst 26 is located upstream of the second exhaust gas control catalyst 27. The catalyst carrier of the first exhaust gas control catalyst 26 is formed of a material that serves as an electrical resistance and generates heat upon being energized. For example, silicon carbide can be used as this material. Incidentally, the catalyst carrier has the properties of exhibiting a lower electrical resistance at high temperature than at low temperature.

A first electrode 211 and a second electrode 212 are attached to the first exhaust gas control catalyst 26. The first electrode 211 is a positive electrode, and the second electrode 212 is a negative electrode. A current is caused to flow through the first exhaust gas control catalyst 26 by applying a voltage to a region between the first electrode 211 and the second electrode 212. When the current flows through the first exhaust gas control catalyst 26, the catalyst carrier generates heat due to the electrical resistance of the catalyst carrier.

In order to cause a current to flow through the entire catalyst carrier homogeneously, the first electrode 211 and the second electrode 212 extend in a circumferential direction and an axial direction along an outer peripheral surface of the catalyst carrier. Besides, each of the first electrode 211 and the second electrode 212 penetrates the case 24.

An insulating glass 213 consisting of an insulating material such as alumina is fitted between each of the first electrode 211 and the second electrode 212 and the case 24. Besides, an insulating coat is formed on an inner peripheral surface of the case 24 by applying the insulating material thereto. That is, the insulating coat is formed on a region of the case 24 as the exhaust pipe where the catalyst carrier is arranged. For example, a glass coat can be used as the insulating coat. Thus, the first exhaust gas control catalyst 26 is electrically insulated from the case 24. Incidentally, the insulating coat has the properties of exhibiting a lower electrical resistance at high temperature than at low temperature.

As described above, the first electrode 211 and the second electrode 212 are attached to the first exhaust gas control catalyst 26. Thus, the first exhaust gas control catalyst 26 serves as the electrically heated catalyst 210 that generates heat by being supplied with electric power. The electrically heated catalyst 210 will be referred to hereinafter as an EHC 210. The first exhaust gas control catalyst 26 is heated and the activation thereof is accelerated, through the generation of heat by the catalyst carrier resulting from energization.

Besides, when the internal combustion engine 11 operates and exhaust gas flows, heat moves to the second exhaust gas control catalyst 27 as well due to the exhaust gas that has been warmed in passing through the EHC 210. Thus, the warm-up of the second exhaust gas control catalyst 27 is also accelerated.

Each of the first electrode 211 and the second electrode 212 is connected to the electric power supply device 220 by a power cable. The EHC 210 is thus connected to the battery 50 via an electric power supply circuit 221 of the electric power supply device 220. The electric power supply device 220 is equipped with the electric power supply circuit 221 that includes an insulated transistor and a power switching element, and an electric power supply microcomputer 222 that is an electric power supply control device for controlling the electric power supply circuit 221. The electric power supply circuit 221 is provided with a current sensor 224 and a voltage sensor 225. The current sensor 224 and the voltage sensor 225 are connected to the electric power supply microcomputer 222. The electric power supply microcomputer 222 detects a current supplied to the EHC 210, based on a signal output by the current sensor 224. Besides, the electric power supply microcomputer 222 detects a voltage applied to the EHC 210, based on a signal output by the voltage sensor 225. Incidentally, an auxiliary battery 55 is connected to the electric power supply device 220.

Besides, the electric power supply circuit 221 of the electric power supply device 220 is provided with an electrical leakage sensing circuit 223 for sensing electrical leakage by detecting an insulation resistance Rt of the EHC 210. For example, the electrical leakage sensing circuit 223 is equipped with a reference resistor. In sensing electrical leakage, electric power is supplied from the auxiliary battery 55 to the electric power supply circuit 221 that includes the electrical leakage sensing circuit 223. The electric power supply microcomputer 222 then calculates the insulation resistance Rt of the EHC 210, based on a current value and a voltage value that are detected by the current sensor 224 and the voltage sensor 225 respectively at this time. Incidentally, the insulation resistance Rt is an electrical resistance value of the insulating coat. Electrical leakage is sensed on the grounds that the insulation resistance Rt is low.

The electric power supply device 220 is connected to the control apparatus 100 in a mutually communicable manner. The insulation resistance Rt calculated by the electric power supply microcomputer 222 is output to the control apparatus 100. Besides, the control apparatus 100 outputs a command to the electric power supply device 220, and controls the energization of the EHC 210 via the electric power supply device 220. That is, the control apparatus 100 supplies the electric power of the battery 50 to the EHC 210 via the electric power supply device 220.

As for Running Modes

When there is sufficient room for the state of charge SOC of the battery 50, the vehicle 10 that is a plug-in hybrid electric vehicle runs in a motor running mode in which only the second motor-generator 32 is used as a motive power source for running. At this time, the control apparatus 100 keeps the internal combustion engine 11 stopped. The control apparatus 100 then controls the power control unit 35 such that the second motor-generator 32 generates a torque from which a driving force corresponding to a required driving force is obtained.

Besides, when the state of charge SOC of the battery 50 becomes smaller than a certain value while the vehicle 10 runs in the motor running mode, the control apparatus 100 changes over the running mode of the vehicle 10 from the motor running mode to a hybrid running mode. The hybrid running mode is a running mode in which both the internal combustion engine 11 and the second motor-generator 32 are used as motive power sources for running.

As for Preheating Process

In order to ensure that sufficient exhaust gas control capacity can be exerted immediately after the changeover to the hybrid running mode, it is desirable to energize the EHC 210 to warm up the first exhaust gas control catalyst 26 before making a changeover to the hybrid running mode to start up the internal combustion engine 11.

Therefore, the control apparatus 100 performs a preheating process for energizing the EHC 210 with the electric power of the battery 50 to warm up the first exhaust gas control catalyst 26 prior to the startup of the internal combustion engine 11.

The control apparatus 100 performs the preheating process when an EHC energization request is ON. Incidentally, the EHC energization request is turned ON when both the following conditions are fulfilled.

One of the conditions is that the state of charge SOC is lower than a threshold for a changeover to the hybrid running mode.

The other condition is that the temperature of the first exhaust gas control catalyst 26 is equal to or lower than a prescribed temperature that is lower than an activation temperature.

The control apparatus 100 estimates the temperature of the first exhaust gas control catalyst 26 based on the coolant temperature Tw detected by the coolant temperature sensor 101. For example, the control apparatus 100 regards the coolant temperature Tw detected by the coolant temperature sensor 101 as the temperature of the first exhaust gas control catalyst 26, and determines whether the temperature of the first exhaust gas control catalyst 26 is equal to or lower than the prescribed temperature that is lower than the activation temperature.

When the energization request is turned ON, the control apparatus 100 starts the preheating process. Incidentally, the control apparatus 100 prohibits the internal combustion engine 11 from being started up while performing the preheating process. The control apparatus 100 continues to energize the EHC 210 until the amount of electric power that is an integrated value of input electric power reaches a target amount of electric power, in the preheating process. Thus, the first exhaust gas control catalyst 26 is heated to a temperature equal to or higher than the activation temperature and warmed up. Incidentally, the target amount of electric power is set based on an amount of electric power that is needed to heat the first exhaust gas control catalyst 26 until the completion of warm-up. Besides, the amount of electric power is an integrated value of the electric power actually supplied to the EHC 210.

The control apparatus 100 controls the electric power supply circuit 221 to convert the voltage of the battery 50 and supply electric power to the EHC 210, in the preheating process. When the temperature of the first exhaust gas control catalyst 26 rises through the preheating process, the electrical resistance of the EHC 210 gradually falls as a result. Therefore, the control apparatus 100 lowers the voltage as the electrical resistance falls, and holds the input electric power equal to a certain electric power. Besides, the control apparatus 100 controls the voltage within a range equal to or lower than an upper-limit voltage set in advance, such that the voltage does not exceed the value of the upper-limit voltage. That is, the upper-limit voltage is an upper limit of the voltage at the time when the voltage is controlled in the preheating process. Incidentally, upon the start of energization, the control apparatus 100 reads a current value detected by the current sensor 224 and a voltage value detected by the voltage sensor 225, and starts integrating the input electric power. The control apparatus 100 then continues to calculate the amount of electric power input to the EHC 210 by integrating the input electric power, while the EHC 210 is energized.

The control apparatus 100 determines whether the calculated amount of electric power has reached the target amount of electric power. Then, if it is determined that the amount of electric power has reached the target amount of electric power, the control apparatus 100 stops energizing the EHC 210. That is, the control apparatus 100 continues energization from the battery 50 until the amount of electric power reaches the target amount of electric power. Then, when the amount of electric power reaches the target amount of electric power, the control apparatus 100 ends the preheating process by ending energization from the battery 50.

Then, upon ending the preheating process, the control apparatus 100 allows the internal combustion engine 11 to be started up, and starts up the internal combustion engine 11.

By the way, the control apparatus 100 confirms the insulation resistance Rt of the EHC 210 before starting the preheating process.

In the vehicle 10, when the system is activated, the electric power supply microcomputer 222 detects the insulation resistance Rt through the use of the electrical leakage sensing circuit 223 as described above. Incidentally, as described above, the electric power of the auxiliary battery 55 is supplied to the EHC 210 to detect the insulation resistance Rt at this time.

When the EHC energization request is turned ON, the control apparatus 100 reads and acquires the insulation resistance Rt detected in activating the system. The control apparatus 100 then determines whether the insulation resistance Rt is higher than a prescribed value Rt_x, before starting the preheating process. The prescribed value Rt_x is a threshold for determining that the insulation resistance Rt is high enough to suppress the occurrence of electrical leakage on the grounds that the insulation resistance Rt is higher than the prescribed value Rt_x. When the insulation resistance Rt is equal to or lower than the prescribed value Rt_x, the control apparatus 100 prohibits the EHC 210 from being energized.

When the EHC 210 is prohibited from being energized, the control apparatus 100 does not energize the EHC 210 even in the case where the EHC energization request is ON. That is, in this case, the control apparatus 100 starts up the internal combustion engine 11 without performing the preheating process.

As for Recovery Process

The control apparatus 100 performs a recovery process for recovering the insulation resistance Rt that has fallen. When the particulate matter contained in exhaust gas adheres to the interior of the case 24 on which the insulating coat is formed, a conduction path may be formed by the carbon contained in the particulate matter. That is, due to the continuation of the carbon that has adhered to the surface of the insulating coat, a conduction path that joins the first exhaust gas control catalyst 26 through which a current flows and a region where the insulating coat is not formed to each other may be formed. Incidentally, in the catalytic converter 29, the case 24 extends farther upstream than the region where the first exhaust gas control catalyst 26 is accommodated, as shown in FIG. 2. The case 24 extends as far as a position spaced apart from the first exhaust gas control catalyst 26 through which the current flows, so the surface area of the case 24 to the region where the insulating coat is not formed increases. Thus, an effect of restraining a conduction path from being formed can be expected.

The recovery process is a process of burning off the conduction path resulting from carbon, through the use of the heat of exhaust gas in the internal combustion engine 11. When the recovery process is performed, the insulation resistance Rt may be recovered.

As for Regeneration Process

When particulate matter is deposited in the filter 36, the resistance of exhaust gas in the exhaust passage 21 increases. Therefore, the control apparatus 100 performs a regeneration process for regenerating the filter 36 by removing the particulate matter deposited in the filter 36. In the regeneration process, the control apparatus 100 raises the temperature of exhaust gas flowing into the filter 36, and oxidizes the particulate matter deposited in the filter 36.

Incidentally, the control apparatus 100 estimates a deposition amount PM of the particulate matter in the filter 36, based on a pressure of exhaust gas between the catalytic converter 29 and the filter 36 that is detected by the exhaust gas pressure sensor 104. As the amount of particulate matter deposited in the filter 36 increases, the pressure of exhaust gas detected by the exhaust gas pressure sensor 104 rises. Thus, the control apparatus 100 estimates that the deposition amount PM increases as the pressure of exhaust gas detected by the exhaust gas pressure sensor 104 rises.

Then, the control apparatus 100 performs the regeneration process when the deposition amount PM estimated based on the pressure of exhaust gas is larger than a threshold PM_y. Incidentally, the control apparatus 100 ends the regeneration process when the deposition amount PM becomes equal to “0”.

As for Performance Sequence of Regeneration Process and Recovery Process

As described hitherto, both the regeneration process and the recovery process are designed to remove the particulate matter through oxidation. The particulate matter deposited at a front end portion of the EHC 210, namely, in the region of the case 24 located upstream of the EHC 210 is removed through the recovery process. In the vehicle 10, the filter 36 is provided downstream of the EHC 210. In this case, exhaust gas that has reached a higher temperature than the exhaust gas delivered to the EHC 210 is introduced into the filter 36, due to oxidation heat of the particulate matter resulting from the recovery process and reaction heat in the EHC 210. As a result, an oxidation reaction of the particulate matter deposited in the filter 36 progresses in a chain-reaction manner, so the temperature of the filter 36 may rise excessively.

Thus, the control apparatus 100 first performs the regeneration process if it is determined that the deposition amount PM is equal to or larger than a prescribed amount PM_x when a condition for performing the recovery process is fulfilled. That is, when it is determined that the insulation resistance Rt is equal to or lower than the prescribed value Rt_x and it is determined that the deposition amount PM is equal to or larger than the prescribed amount PM_x, the control apparatus 100 performs the regeneration process and then the recovery process. Incidentally, the prescribed amount PM_x is smaller in value than the threshold PM_y. The prescribed amount PM_x is a threshold for determining that the temperature of the filter 36 may become excessively high as a result of the reaction of the particulate matter deposited in the filter 36 in a chain-reaction manner in the case where the recovery is performed.

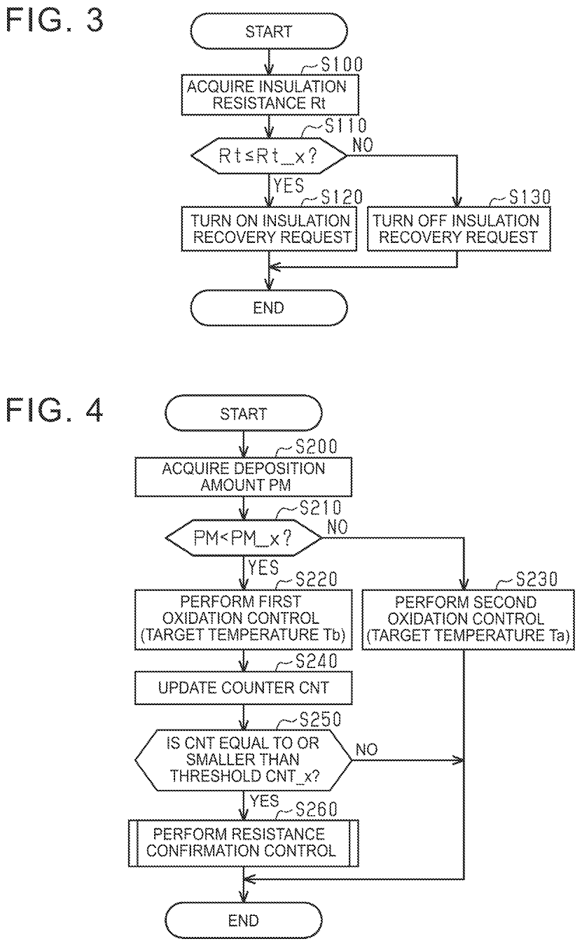

Next, the flow of a process regarding the performance sequence of the regeneration process and the recovery process will be described with reference to FIGS. 3 and 4.

As for Insulation Recovery Request

First of all, a routine regarding the operation of an insulation recovery request that is a request for the performance of the recovery process will be described with reference to FIG. 3. The routine shown in FIG. 3 is repeatedly executed by the control apparatus 100 while the internal combustion engine 11 is in operation.

When this routine is started, the control apparatus 100 first acquires the insulation resistance Rt in the processing of step S100. In concrete terms, the control apparatus 100 reads and acquires the latest insulation resistance Rt that has been detected. For example, the control apparatus 100 reads and acquires the insulation resistance Rt detected in activating the system. Then in the subsequent processing of step S110, the control apparatus 100 determines whether the acquired insulation resistance Rt is equal to or lower than the prescribed value Rt_x.

If it is determined in the processing of step S110 that the insulation resistance Rt is equal to or lower than the prescribed value Rt_x (YES in step S110), the control apparatus 100 advances the process to step S120. The control apparatus 100 then turns the insulation recovery request ON in the processing of step S120. Incidentally, the insulation recovery request is OFF in an initial state. Every time the power switch 102 is turned OFF to stop the operation of the system of the vehicle 10, the insulation recovery request is reset to be turned OFF. Incidentally, when the insulation resistance Rt is equal to or lower than the prescribed value Rt_x, the EHC 210 is prohibited from being energized as described above. Therefore, when the insulation recovery request is ON, the EHC 210 is not energized, and the internal combustion engine 11 is allowed to be started up without performing the preheating process.

On the other hand, if it is determined in the processing of step S110 that the insulation resistance Rt is higher than the prescribed value Rt_x (NO in step S110), the control apparatus 100 advances the process to step S130. The control apparatus 100 then turns the insulation recovery request OFF in the processing of step S130. As will be described later, when the recovery process is ended, the control apparatus 100 detects the insulation resistance Rt again. Therefore, when the insulation resistance Rt is recovered through the recovery process, the insulation recovery request is reset to be turned OFF through the processing of step S130 in this routine. Besides, when the insulation resistance Rt becomes higher than the prescribed value Rt_x, the prohibition of energization of the EHC 210 is cancelled.

When the processing of step S120 and step S130 is thus performed and a process of updating the insulation recovery request is performed, the control apparatus 100 ends this routine temporarily.

Incidentally, if the insulation resistance Rt is recovered when the recovery process is ended, the prohibition of energization of the EHC 210 is canceled. However, even when the recovery process is ended, the insulation resistance Rt may not be recovered and may continue to be equal to or lower than the prescribed value Rt x. In this case, it may be determined that an abnormality of insulation failure has occurred.

As for Recovery Process and Regeneration Process Performed when Insulation Recovery Request is ON

FIG. 4 shows the flow of a process of a routine that is repeatedly performed by the control apparatus 100 when the insulation recovery request is ON. As shown in FIG. 4, when this routine is started, the control apparatus 100 first acquires the deposition amount PM in the processing of step S200. In concrete terms, the control apparatus 100 reads and acquires the deposition amount PM estimated based on the pressure of exhaust gas detected by the exhaust gas pressure sensor 104 as described above. The control apparatus 100 then advances the process to step S210.

In the processing of step S210, the control apparatus 100 determines whether the deposition amount PM is smaller than the prescribed amount PM_x. That is, in the processing of step S210, it is determined whether the filter 36 is prevented from being heated excessively even when the recovery process is performed.

If it is determined in the processing of step S210 that the deposition amount PM is smaller than the prescribed amount PM_x (YES in step S210), the control apparatus 100 advances the process to step S220. The control apparatus 100 then performs first oxidation control as the recovery process, in the processing of step S220. That is, if it is determined that the deposition amount PM is smaller than the prescribed amount PM_x and that the filter 36 is prevented from being heated excessively even when the recovery process is performed, the control apparatus 100 performs the recovery process.

On the other hand, if it is determined in the processing of step S210 that the deposition amount PM is equal to or larger than the prescribed amount PM_x (NO in step S210), the control apparatus 100 advances the process to step S230. The control apparatus 100 then performs second oxidation control as the regeneration process in the processing of step S230. That is, if it is determined that the deposition amount PM is equal to or larger than the prescribed amount PM_x and that the filter 36 may be heated excessively when the recovery process is performed, the control apparatus 100 performs the regeneration process without performing the recovery process.

As described above, both the regeneration process and the recovery process are oxidation control for oxidizing the particulate matter by raising the temperature of exhaust gas discharged from combustion chambers of the internal combustion engine 11. First oxidation control performed as the recovery process and second oxidation control performed as the regeneration process are different from each other in the target temperature of exhaust gas discharged from the combustion chambers.

In the case of second oxidation control as the regeneration process for oxidizing the particulate matter deposited in the filter 36, a relatively low target temperature Ta is set in consideration of reaction heat in the first exhaust gas control catalyst 26 and the second exhaust gas control catalyst 27 that are located upstream of the filter 36.

In concrete terms, the target temperature Ta is set as a temperature that allows the particulate matter to be oxidated through the flow of exhaust gas of which the temperature has risen due to reaction heat in the first exhaust gas control catalyst 26 and the second exhaust gas control catalyst 27 into the filter 36. Besides, the target temperature Ta is set such that the filter 36 is not heated excessively as a result of oxidation of the particulate matter deposited in the filter 36 in a chain-reaction manner.

On the other hand, in the case of the recovery process for oxidizing the carbon contained in the particulate matter that has adhered to the front end portion of the EHC 210, namely, the region of the case 24 located upstream of the EHC 210, the particulate matter needs to be oxidized regardless of the reaction heat of the catalyst. Therefore, a target temperature Tb in first oxidation control performed as the recovery process is higher than the target temperature Ta. The target temperature Tb is set as a temperature that allows the particulate matter to be oxidized.

Incidentally, the control apparatus 100 raises the temperature of exhaust gas by retarding the ignition timing in both first oxidation control as the recovery process of step S220 and second oxidation control as the regeneration process of step S230. That is, the control apparatus 100 retards the ignition timing more than when oxidation control is not performed. By retarding the ignition timing, the process of combustion is slowed down, and the temperature of exhaust gas becomes high. In first oxidation control, the temperature of exhaust gas is made higher than in second oxidation control, by increasing the amount of retardation of the ignition timing.

As described hitherto, the ignition timing is retarded such that the temperature of exhaust gas discharged from the combustion chambers becomes equal to the target temperature Ta in second oxidation control, and the ignition timing is retarded more such that the temperature of exhaust gas discharged from the combustion chambers becomes equal to the target temperature Tb in first oxidation control.

Besides, the control apparatus 100 increases the output of the internal combustion engine 11 by increasing the amount of fuel injection more than when oxidation control is not performed. Thus, a fall in output resulting from the retardation of the ignition timing can be compensated for. Besides, the amount of heat input per unit time can be increased by increasing the flow rate of exhaust gas.

In the processing of step S230, when second oxidation control as the regeneration process is performed, the control apparatus 100 temporarily ends this series of processing steps. The deposition amount PM in the filter 36 gradually decreases through the performance of the regeneration process. Therefore, through repeated execution of this routine, the deposition amount PM eventually becomes smaller than the prescribed amount PM_x, and the result of determination in step S210 becomes positive (YES in step S210). That is, a shift from the regeneration process to the recovery process is made eventually.

In the processing of step S220, when first oxidation control as the recovery process is performed, the control apparatus 100 advances the process to step S240 to update a counter CNT. The counter CNT is set to a prescribed value when it is determined that the insulation resistance Rt is equal to or lower than the prescribed value Rt_x and the EHC 210 is prohibited from being energized. In the processing of step S240, the control apparatus 100 updates the value of the counter CNT through subtraction. A subtraction amount that is subtracted from the value of the counter CNT in the processing of step S240 is set in accordance with an air-fuel ratio of exhaust gas upstream of the catalytic converter 29 that is detected by the upstream air-fuel ratio sensor 105. In concrete terms, the value of the counter CNT is set in such a manner as to increase as the air-fuel ratio detected by the upstream air-fuel ratio sensor 105 rises, namely, as the amount of oxygen contained in exhaust gas increases.

When the value of the counter CNT is thus updated in the processing of step S240, the control apparatus 100 advances the process to step S250. Then in the processing of step S250, the control apparatus 100 determines whether the value of the counter CNT is equal to or smaller than a threshold CNT_x that is an end determination value.

If it is determined in the processing of step S250 that the value of the counter CNT is larger than the threshold CNT_x (NO in step S250), the control apparatus 100 ends this routine temporarily. On the other hand, if it is determined in the processing of step S250 that the value of the counter CNT is equal to or smaller than the threshold CNT_x (YES in step S250), the control apparatus 100 advances the process to step S260. Then in the processing of step S260, the control apparatus 100 performs resistance confirmation control.

In this resistance confirmation control, the electric power supply microcomputer 222 first detects the insulation resistance Rt through the use of the electrical leakage sensing circuit 223, in the same manner as in the case where the system is activated. Subsequently, the control apparatus 100 executes the routine described with reference to FIG. 3. Then, if the insulation resistance Rt detected again is higher than the prescribed value Rt_x (NO in step S110), the control apparatus 100 updates the insulation recovery request to OFF (step S130). The control apparatus 100 then ends resistance confirmation control, and ends this routine.

When the insulation recovery request is turned OFF, this routine is stopped from being executed, and the recovery process is also stopped from being performed. That is, the control apparatus 100 ends the recovery process by updating the insulation recovery request to OFF in the processing of step S260.

On the other hand, when the insulation resistance Rt detected again remains equal to or lower than the prescribed value Rt_x (YES in step S110), the control apparatus 100 holds the insulation recovery request ON (step S120). The control apparatus 100 then ends resistance confirmation control, and ends this routine.

Since the insulation recovery request remains ON, the recovery process is performed again in this case. Incidentally, when the insulation resistance Rt is not recovered despite repeated performance of the recovery process, it may be determined that there is an abnormality in the EHC 210.

As described hitherto, when the recovery process is started, the control apparatus 100 repeatedly executes this routine and continues the recovery process until it is determined in the processing of step S250 that the value of the counter CNT is equal to or smaller than the threshold CNT_x. The magnitude of the prescribed value set as an initial value of the counter CNT and the magnitude of the subtraction amount are set based on a result of an experiment conducted in advance or the like, such that the recovery process can be continued over a period that is needed to recover the insulation resistance Rt.

(Operation)

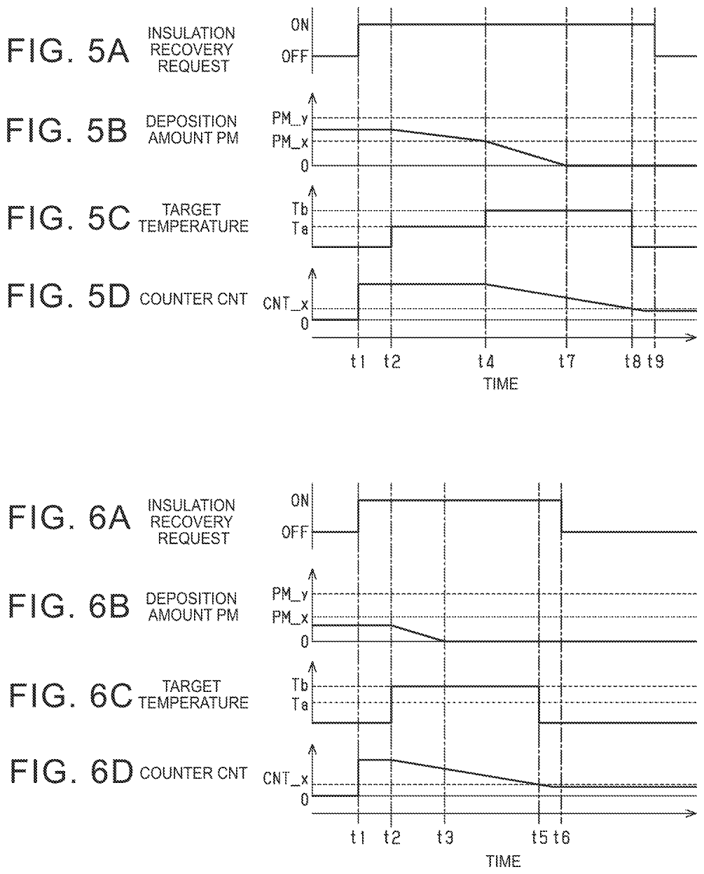

Next, the operation of the control apparatus 100 will be described with reference to FIGS. 5A to 5D and FIGS. 6A to 6D. Incidentally, FIGS. 5A to 5D and FIGS. 6A to 6D are time charts showing changes in the deposition amount PM at the time of the performance of the recovery process. FIGS. 5B and 6B indicate changes in the deposition amount PM. FIGS. 5A and 6A indicate changes in the state of the insulation recovery request. FIGS. 5C and 6C indicate changes in the target temperature in oxidation control. FIGS. 5D and 6D indicate changes in the value of the counter CNT.

Incidentally, in FIGS. 5A to 5D and FIGS. 6A to 6D, time is denoted by “t” followed by a number. FIGS. 5A to 5D and FIGS. 6A to 6D show that a shift from an earlier time to a later time is made as the number following “t” increases. For example, “t4” in FIGS. 5A to 5D is later than “t3” in FIGS. 6A to 6D.

FIGS. 5A to 5D are time charts showing changes in the respective values at the time when it is determined that the insulation resistance Rt is equal to or lower than the prescribed value Rt_x and it is determined that the deposition amount PM is equal to or larger than the prescribed amount PM_x. FIGS. 6A to 6D are time charts showing changes in the respective values at the time when it is determined that the insulation resistance Rt is equal to or lower than the prescribed value Rt_x and it is determined that the deposition amount PM is smaller than the prescribed amount PM_x.

If it is determined at time t1 that the insulation resistance Rt is equal to or lower than the prescribed value Rt_x (NO in step S110), the insulation recovery request is updated from OFF to ON as shown in FIG. 5A (step S120). Thus, the value of the counter CNT is set as a prescribed value.

When the routine shown in FIG. 4 is started at time t2, the deposition amount PM is equal to or larger than the prescribed amount PM_x (NO in step S210) as shown in FIG. 5B, second oxidation control is started as the regeneration process (step S230). Thus, oxidation control is performed such that the temperature of exhaust gas discharged from the combustion chambers of the internal combustion engine 11 becomes equal to the target temperature Ta, as shown in FIG. 5C.

When the regeneration process is thus started at time t2, the deposition amount PM gradually decreases as shown in FIG. 5B. If the deposition amount PM becomes equal to or smaller than the prescribed amount PM_x at time t4 (YES in step S210), first oxidation control is started as the recovery process (step S220). That is, the process performed by the control apparatus 100 shifts from the regeneration process to the recovery process. Thus, second oxidation control is performed such that the temperature of exhaust gas discharged from the combustion chambers of the internal combustion engine 11 becomes equal to the target temperature Tb that is higher than the target temperature Ta, as shown in FIG. 5C.

When the recovery process is started at time t4, the updating of the value of the counter CNT is started (step S250). Thus, the value of the counter CNT gradually decreases from time t4, as shown in FIG. 5D.

At this time, the particulate matter at the front end portion of the EHC 210 is removed through oxidation by the recovery process, and the exhaust gas warmed by oxidation heat and the reaction heat in the catalytic converter 29 is introduced into the filter 36 located downstream of the catalytic converter 29. Therefore, the particulate matter continues to be oxidized in the filter 36 as well. Therefore, the deposition amount PM continues to decrease from time t4 as well, as shown in FIG. 5B. Incidentally, the deposition amount PM is “0” at time t7 in FIG. 5B.

As shown in FIG. 5D, if it is determined at time t8 that the value of the counter CNT has become equal to or smaller than the threshold CNT_x (YES in step S250), resistance confirmation control is performed (step S260). Then, if the insulation resistance Rt is higher than the prescribed value Rt_x (NO in step S110), the insulation recovery request is updated to OFF at time t9, as shown in FIG. 5A. Thus, the recovery process is ended.

As described hitherto, according to the control apparatus 100, the regeneration process is first performed when it is determined that the insulation resistance Rt is equal to or smaller than the prescribed value Rt_x and it is determined that the deposition amount PM is equal to or larger than the prescribed amount PM_x. The recovery process is then performed after the deposition amount PM decreases through the regeneration process.

Next, the operation at the time when it is not determined that the deposition amount PM is equal to or larger than the prescribed amount PM_x will be described with reference to FIGS. 6A to 6D.

In this case as well, if it is determined at time t1 that the insulation resistance Rt is equal to or lower than the prescribed value Rt_x (NO in step S110), the insulation recovery request is updated from OFF to ON (step S120), as shown in FIG. 6A. Thus, the counter CNT is set as the prescribed value.

In this case, the deposition amount PM is smaller than the prescribed amount PM_x (YES in step S210) as shown in FIG. 6B. Therefore, in this case, when the route shown in FIG. 4 is started at time t2, first oxidation control is started as the recovery process (step S220). Thus, first oxidation control is performed such that the temperature of exhaust gas discharged from the combustion chambers of the internal combustion engine 11 becomes equal to the target temperature Tb, as shown in FIG. 6C. While the recovery process is performed as described above, the deposition amount PM continues to decrease. Therefore, when the recovery process is thus started at time t2, the deposition amount PM gradually decreases as shown in FIG. 6B. Incidentally, in FIG. 6B, the deposition amount PM is “0” at time t3.

When the recovery process is started at time t2, the updating of the value of the counter CNT is started (step S250). Thus, the value of the counter CNT gradually decreases from time t2, as shown in FIG. 6D.

If it is determined at time t5 that the value of the counter CNT has become equal to or smaller than the threshold CNT_x (YES in step S250) as shown in FIG. 6D, resistance confirmation control is performed (step S260). Then, if the insulation resistance Rt is higher than the prescribed value Rt_x (NO in step S110), the insulation recovery request is updated to OFF at time t6, as shown in FIG. 6A. Thus, the recovery process is ended.

As described hitherto, according to the control apparatus 100, the recovery process is performed without performing the regeneration process when it is determined that the insulation resistance Rt is equal to or lower than the prescribed value Rt_x and it is not determined that the deposition amount PM is equal to or larger than the prescribed amount PM_x. Then, the particulate matter at the front end portion of the EHC 210 and the particulate matter deposited in the filter 36 are removed through the recovery process.

### Effects

The effects of the present embodiment will be described.

(1) In the control apparatus 100, when it is determined that the insulation resistance Rt is equal to or lower than the prescribed value Rt_x and it is determined that the deposition amount PM is equal to or larger than the prescribed amount PM_x, the regeneration process is performed first. Therefore, when the recovery process is performed, the deposition amount PM of the particulate matter in the filter 36 is small. Even in the case where the exhaust gas that has reached a high temperature due to the reaction heat on the upstream side resulting from the recovery process is introduced into the filter 36. when the deposition amount PM is small, the particulate matter burns off, and the oxidation reaction that occurs in a chain-reaction manner is likely to come to an end. Therefore, the temperature of the filter 36 can be restrained from becoming excessively high.

(2) In the control apparatus 100, when it is determined that the insulation resistance Rt is equal to or lower than the prescribed value Rt_x and it is not determined that the deposition amount PM is equal to or larger than the prescribed amount PM_x, the recovery process is performed without performing the regeneration process. Therefore, both the particulate matter at the front end portion of the EHC 210 and the particulate matter deposited in the filter 36 can be removed by performing the recovery process once.

(3) As shown in FIGS. 5A to 5D, in the control apparatus 100, when the regeneration process is performed prior to the recovery process on the grounds that it is determined that the insulation resistance Rt is equal to or lower than the prescribed value Rt_x and that it is determined that the deposition amount PM is equal to or larger than the prescribed amount PM_x, a shift from the regeneration process to the recovery process is made as soon as the deposition amount PM becomes smaller than the prescribed amount PM_x. That is, the control apparatus 100 ends the regeneration process before the deposition amount PM becomes equal to “0”. In short, in this case, the control apparatus 100 ends the regeneration process with the deposition amount PM being larger than in the case where the regeneration process is performed when it is not determined that the insulation resistance Rt is equal to or lower than the prescribed value Rt_x, and starts the recovery process.

In the case where the regeneration process is performed prior to the recovery process, high-temperature exhaust gas continues to be introduced into the filter 36 even during the recovery process that is performed subsequently to the regeneration process. Therefore, the particulate matter deposited in the filter 36 can be oxidized during the performance of the recovery process as well. Accordingly, even if the regeneration process is ended with the deposition amount PM being larger than in the case where the regeneration process is performed when it is not determined that the insulation resistance Rt is equal to or lower than the prescribed value Rt_x, the deposition amount PM can be reduced sufficiently. Accordingly, the control apparatus 100 can shorten the period during which the regeneration process is performed, and make a swift shift to the recovery process.

(4) A swift shift to the recovery process can be made as described above. Therefore, the insulation resistance Rt can be recovered at an early stage, and the prohibition of energization can be canceled swiftly.

(5) The likelihood of oxidation of the particulate matter increases as the amount of oxygen increases. Therefore, the period during which the recovery process is performed can be shortened as the amount of oxygen contained in exhaust gas increases. In the control apparatus 100, the period during which the recovery process is performed is shortened as the amount of oxygen contained in exhaust gas discharged from the combustion chambers increases. Therefore, the recovery process can be restrained from being performed more than necessary.

### Modification Examples

The present embodiment can be carried out after being modified as follows. The present embodiment and the following modification examples can be carried out in combination with one another within such a range that no technical contradiction occurs.

The likelihood of oxidation of the particulate matter increases as the temperature rises. The subtraction amount subtracted from the value of the counter CNT may be set in such a manner as to increase as the temperature of exhaust gas discharged from the combustion chambers of the internal combustion engine 11 rises.

The method of deciding the timing for ending the recovery process through the use of the counter CNT has been exemplified, but the disclosure is not limited to this method. Different methods are also applicable. Besides, the example of reducing the value of the counter CNT has been exemplified. However, the value of the counter CNT may be increased, and the recovery process may be ended on the condition that the value of the counter CNT has reached a threshold.

Although the example of subtraction from the value of the counter CNT only during the performance of the recovery process has been presented, it is also possible to adopt a specification in which subtraction from the value of the counter CNT is carried out during the performance of the regeneration process. The particulate matter at the front end portion of the EHC 210 can be oxidized during the regeneration process if exhaust gas is at a certain temperature. The target temperature Ta in second oxidation control as the regeneration process is required only to be set as a temperature at which the filter 36 is not excessively heated even when oxidation heat and reaction heat are applied thereto.

In the regeneration process, the control of supplying oxygen to the filter 36 may be performed additionally. For example, oxygen can be supplied to the filter 36 by, for example, stopping the injection of fuel to one or some of the cylinders and the ignition therein, and discharging air to the exhaust passage 21 from the cylinders or cylinder. If oxygen is thus supplied, a sufficient amount of oxygen can be supplied to the filter 36 even when oxygen is occluded by the three-way catalyst provided in the catalytic converter 29. By supplying oxygen to the filter 36, combustion is accelerated, and the regeneration process can be completed swiftly. Besides, the average air-fuel ratio may be held close to a theoretical air-fuel ratio by increasing the amount of fuel injection to the other cylinders or cylinder.

The method of determining that the deposition amount PM is equal to or larger than the prescribed amount PM_x can be changed as appropriate. For example, it may be determined that the deposition amount PM is equal to or larger than the prescribed amount PM_x on the grounds that the pressure of exhaust gas is equal to or higher than a threshold.

The deposition amount PM of the particulate matter in the filter 36 may be estimated regardless of the pressure of exhaust gas. For example, the deposition amount PM may be calculated from the flow rate of exhaust gas. Furthermore, the amount of the particulate matter flowing into the filter 36 may be calculated in consideration of the influence resulting from the reaction in the three-way catalyst. Besides, the subtraction amount of the particulate matter in exhaust gas resulting from oxidation through the recovery process may be calculated, and this subtraction amount may also be reflected in calculating the deposition amount PM.

The configuration of the catalytic converter 29 may be changed as appropriate. For example, the catalytic converter 29 may be configured not to be equipped with the second exhaust gas control catalyst 27.

The catalyst carried by the catalyst carrier of each of the exhaust gas control catalysts may not necessarily be a three-way catalyst, but may be, for example, an oxidation catalyst, an occlusion reduction-type NOx catalyst, or a selective reduction-type NOx catalyst.

As an example of the electrically heated catalyst, the EHC 210 with the exhaust gas control catalyst itself heated by causing current to flow therethrough has been exemplified. However, the electrically heated catalyst may not necessarily be configured in this manner. For example, the electrically heated catalyst may be configured such that the exhaust gas control catalyst is heated through the use of a heater that is provided at a position adjacent to the exhaust gas control catalyst and that generates heat through energization.

The vehicle 10 mounted with the electrically heated catalyst system 200 and the control apparatus 100 may not necessarily be a plug-in hybrid electric vehicle, but may also be a hybrid electric vehicle with no plug-in function, or a vehicle that uses only the internal combustion engine 11 as a motive power source. In the examples of these vehicles that are not a plug-in hybrid electric vehicle, the request for energization of the EHC 210 is ON when there is a request for startup of the internal combustion engine 11 and the temperature of the EHC 210 is equal to or lower than a predetermined value.

The control apparatus 100 can be configured as at least one dedicated hardware circuit such as at least one processor that performs various processes in accordance with a computer program (software), or an application specific integrated circuit (ASIC) that performs at least one of various processes. Besides, the control apparatus 100 can also be configured as a circuitry including a combination of these components. The processor includes a CPU and memories such as a RAM and a ROM, and each of the memories stores a program code or command configured to cause the CPU to perform processes. The memories, namely, computer-readable media include all available media that can be accessed by a general-purpose or dedicated computer.

Besides, the example in which the control apparatus for the internal combustion engine is concretized as the control apparatus 100 for controlling the power train of the vehicle 10 has been presented. In contrast, the control apparatus for the internal combustion engine may be configured as a dedicated control apparatus that controls the internal combustion engine 11.

What is claimed is:

1. A control apparatus for an internal combustion engine to which the control apparatus is applied and that is mounted with an electrically heated catalyst system having an electrically heated catalyst that is an exhaust gas control catalyst having a catalyst carried by a catalyst carrier generating heat through energization and that causes the catalyst carrier to generate heat by energizing the catalyst carrier, with the electrically heated catalyst and a filter for collecting particulate matter contained in exhaust gas arranged in an exhaust passage in a sequence of the electrically heated catalyst and the filter from an upstream side, the control apparatus performing a regeneration process for removing the particulate matter deposited in the filter through oxidation, and a recovery process for removing the particulate matter deposited at a front end portion of the electrically heated catalyst through oxidation when it is determined that an insulation resistance of the electrically heated catalyst is equal to or lower than a prescribed value, wherein
the regeneration process is a process of raising a temperature of exhaust gas discharged from a combustion chamber of the internal combustion engine to a temperature that is higher than prior to start of the regeneration process,
the recovery process is a process of raising the temperature of exhaust gas discharged from the combustion chamber to a temperature that is higher than in a case of the regeneration process, and
the regeneration process is performed and then the recovery process is performed when it is determined that the insulation resistance is equal to or lower than the prescribed value and it is determined that a deposition amount of the particulate matter in the filter is equal to or larger than a prescribed amount.

2. The control apparatus for the internal combustion engine according to claim 1 that estimates the deposition amount based on a pressure of exhaust gas detected by an exhaust gas pressure sensor provided in the exhaust passage downstream of the electrically heated catalyst and upstream of the filter.

3. The control apparatus for the internal combustion engine according to claim 1, wherein
the electrically heated catalyst system is equipped with an electrical leakage sensing circuit for detecting the insulation resistance, and
the insulation resistance is detected through use of the electrical leakage sensing circuit.

4. The control apparatus for the internal combustion engine according to claim 1 that raises the temperature of exhaust gas by retarding an ignition timing in the internal combustion engine, in the regeneration process and the recovery process.

5. The control apparatus for the internal combustion engine according to claim 1 that ends the regeneration process with the deposition amount being larger than in a case where the regeneration process is performed when it is not determined that the insulation resistance is equal to or lower than the prescribed value, and starts the recovery process, in a case where the regeneration process is performed prior to the recovery process when it is determined that the insulation resistance is equal to or lower than the prescribed value and it is determined that the deposition amount is equal to or larger than the prescribed amount.

6. The control apparatus for the internal combustion engine according to claim 1 that shortens a period during which the recovery process is performed as an amount of oxygen contained in exhaust gas discharged from the combustion chamber increases.

7. The control apparatus for the internal combustion engine according to claim 6 that sets a counter to a prescribed value when it is determined that the insulation resistance is equal to or lower than the prescribed value, that repeatedly subtracts, from a value of the counter, a subtraction amount that is set in such a manner as to increase as the amount of oxygen increases, during performance of the recovery process, and that ends the recovery process when the value of the counter falls to or below an end determination value.
